(19) United States
(12) Patent Application Publication
(10) Pub. No.: US 2008/0136329 A1
(43) Pub. Date: Jun. 12, 2008

(54) PLASMA DISPLAY PANEL AND METHOD FOR MANUFACTURING THE SAME

(75) Inventors: Byung Hwa Seo, Seoul (KR); Dae Hyun Park, Seoul (KR); Bum Jin Bae, Gyeonggi-do (KR); Je Seok Kim, Gyeonggi-do (KR); Byung Gil Ryu, Gyeonggi-do (KR); Hong Cheol Lee, Gyeonggi-do (KR); Eun A. Moon, Gyeonggi-do (KR)

Correspondence Address: KED & ASSOCIATES, LLP, P.O. Box 221200, Chantilly, VA, 20153-1200, US

(73) Assignee: LG Electronics Inc.

(21) Appl. No.: 11/954,536

(22) Filed: Dec. 12, 2007

(30) Foreign Application Priority Data
Dec. 12, 2006 (KR) 10-2006-0126308
Mar. 30, 2007 (KR) 10-2007-0031358

(51) Int. Cl. H01J 17/49; H01J 9/00

(52) U.S. Cl. 313/587; 445/24

(57) ABSTRACT

Disclosed are a plasma display panel and a method for manufacturing the same. The method includes preparing a first substrate including an address electrode, a dielectric and a barrier rib, applying a first dielectric to a second substrate including a pair of sustain electrodes, applying a plurality of second dielectrics to the first dielectric with a dispensing system having a nozzle equipped with a plurality of reverse-trapezoid injection ports, such that the second dielectrics have a differential structure, drying the first and second dielectrics, followed by baking, forming a protective film on the first and second dielectrics, and joining the first substrate to the second substrate.

This application claims the benefit of Korean Patent Application No. ______, filed on ______, which is hereby incorporated by reference as if fully set forth herein.

### BACKGROUND OF THE INVENTION

1. Field of the Invention

The present invention relates to a plasma display panel, and more particularly, to a dielectric of a plasma display panel and a method for manufacturing the same.

2. Discussion of the Related Art

With the advent of a multimedia age, there has been a demand for displays that exhibit a higher-definition, have a larger-screen and are capable of realizing excellent natural color reproduction. Since cathode ray tubes (CRTs) have a limitation in realizing a large screen (i.e., 40 inch or more), displays such as liquid crystal displays (LCDs), plasma display panels (PDPs) and projection televisions (TVs) are rapidly progressed to extend applications thereof to the high-definition image field.

When compared to self-luminous CRTs, the fore-mentioned displays including PDPs have essential characteristics in that they can be manufactured to a small thickness, and a large screen (i.e., 60 to 80 inch) is readily manufactured. In addition, the displays are significantly different from self-luminous CRTs, in views of styles and designs.

PDPs include a lower substrate including an address electrode, an upper substrate including a pair of sustain electrodes, discharge cells defined by barrier ribs and a phosphor applied at each discharge cell so as to display an image. Specifically, when discharging occurs in a discharge zone between the upper and lower substrates, ultraviolet rays are generated and transmitted to the phosphor to emit visible rays, thereby displaying an image.

However, the fore-mentioned plasma display panels and a method for manufacturing the same have several problems as follows.

In order to improve luminescent efficiency of PDPs, it is necessary to reduce discharge current thereof. However, the discharge current is greatly affected by the thickness of the dielectric layer. Generally, when a dielectric layer has a small thickness, discharge firing voltage is decreased and discharge current is increased, and when the dielectric layer has a large thickness, the discharge firing voltage is increased and discharge current is decreased. Accordingly, when the thickness of the dielectric layer is simply increased, the discharge current is decreased, but the discharge firing voltage is increased.

Other problems of the conventional PDPs are as follows:

A contrast ratio of PDPs refers to a ratio of a maximum brightness and a minimum brightness. Since PDPs have a light reflection ratio at a bright room, they have a lower bright room contrast ratio than those of other displays such as LCDs. In addition, PDPs exhibit high external-light reflection ratios, thus causing a deterioration in color temperature.

### SUMMARY OF THE INVENTION

Accordingly, the present invention is directed to a plasma display panel and a method for manufacturing the same that substantially obviate one or more problems due to limitations and disadvantages of the related art.

One object of the present invention is to provide a method for forming a differential dielectric on a substrate of a plasma display panel and an apparatus used in the formation of the dielectric.

Another object of the present invention is to provide a plasma display panel with an increased bright room contrast ratio and an improved color temperature.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for manufacturing a plasma display panel comprises: preparing a first substrate including an address electrode, a dielectric and a barrier rib; applying a first dielectric to a second substrate including a pair of sustain electrodes; applying a plurality of second dielectrics to the first dielectric with a dispensing system having a nozzle equipped with a plurality of reverse-trapezoid injection ports, such that the second dielectrics have a differential structure; drying the first and second dielectrics, followed by baking; forming a protective film on the first and second dielectrics; and joining the first substrate to the second substrate.

In another aspect of the present invention, a plasma display panel comprises: a first substrate and a second substrate joined to each other, such that a barrier rib is interposed between the first and second substrates; an address electrode and a dielectric arranged in this order on the first substrate; a pair of sustain electrodes and a first dielectric arranged in this order on the second substrate; a plurality of second dielectrics arranged on the first dielectric, each second dielectric exhibiting a chromatic color, gray or black, and having topology; and a protective film arranged on the first and second dielectrics.

In yet another aspect of the present invention, a method for manufacturing a plasma display panel comprises: preparing a first substrate including an address electrode, a dielectric and a barrier rib; applying a first dielectric to a second substrate including a pair of sustain electrodes; applying a second dielectric composed of a chromatic, gray or black material to a region corresponding to a non-discharge zone of the first dielectric with a dispensing system; drying the first and second dielectrics, followed by baking; forming a protective film on the first and second dielectrics; and joining the first substrate to the second substrate.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating the structure of a discharge cell of a plasma display panel (PDP) according to the present invention;

FIGS. 2A to 2P are sectional views illustrating a method for manufacturing a plasma display panel (PDP) according to the present invention; and

FIG. 3A to 3C are views illustrating a dispensing system used to manufacture a plasma display panel (PDP) according to preferred embodiments of the present invention.

### DETAILED DESCRIPTION OF THE INVENTION

Other aspects, features and advantages of the present invention will be more clearly understood from the following detailed description taken in conjunction with the accompanying drawings.

Reference will now be made in detail to the preferred embodiments of the present invention, examples of which are illustrated in the accompanying drawings. Wherever possible, the same reference numbers will be used throughout the drawings to refer to the same or like parts.

Like numbers refer to like elements throughout the description of the figures. In the drawings, the thickness of layers and regions are exaggerated for clarity and the thickness ratio between the layers may not necessarily express an actual value.

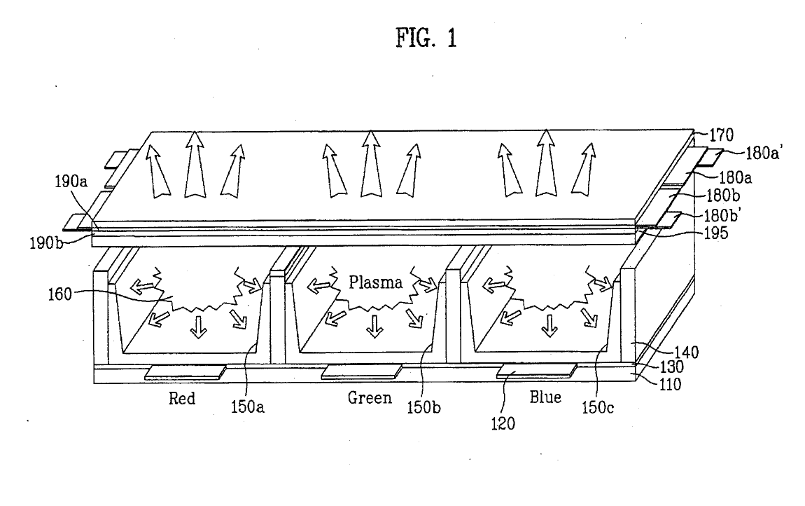

FIG. 1 shows the structure of discharge cells of a plasma display panel (PDP) according to one embodiment of the present invention. An explanation for the structure of the discharge cells with reference to FIG. 1 will be given below.

As shown in FIG. 1, the plasma display panel (PDP) according to the present invention includes an upper substrate 170, a pair of sustain electrodes 180a and 180b arranged on the upper substrate 170 in one direction, and bus electrodes 180a′ and 180b′ composed of a general metallic material.

In addition, the PDP includes dielectrics and a protective film 195 arranged on the upper substrate 170 such that they cover the sustain electrodes and the bus electrodes. The upper substrate 170 is formed by processing (including milling, cleaning and the like) a glass for displays. The sustain electrodes 180a and 180b are formed by photoetching method through sputtering of a material such as indium-tin-oxide (ITO) or SnO₂, or a lift-off method through chemical vapor deposition (CVD) of the material. The bus electrodes 180a′ and 180b are composed of a material such as silver (Ag). In addition, scan electrodes and the sustain electrodes include a black matrix consisting of a low melting point glass and a black pigment.

Dielectrics are arranged over the upper substrate 170 where the sustain electrodes 180a and 180b, and the bus electrodes 180a′ and 180b′ are formed. As shown in FIG. 1, the dielectrics include a first dielectric 190a and a plurality of second dielectrics 190b. The first dielectric 190a includes a transparent low-melting point glass and has a thickness of about 5 to 30.5 micrometers.

The second dielectrics 190b include a metal oxide, in addition to a transparent low-melting point glass. The metal oxide includes at least one selected from cobalt oxide, copper oxide, manganese oxide and chrome oxide. Accordingly, the second dielectrics 190b have a chromatic color, gray or black.

The second dielectrics 190b are formed in a region only corresponding to a non-discharge zone of the first dielectric 190a. That is to say, no second dielectric 190b is formed in a region corresponding to the space between the sustain electrode pairs 180a and 180b. Accordingly, the second dielectrics have a non-uniform thickness and have a differential structure. As shown in FIG. 1, the second dielectrics 190b are in the form of a trapezoid or rectangle. The shape of the second dielectrics 190b is varied according to formation processes. A more detailed explanation of the shape will be given in the following section.

The second dielectrics 190b have a thickness of about 7.5 to 33 micrometers and are arranged to be spaced apart from each other by a distance of 200 to 400 micrometers. The second dielectrics 190b have a width of 276 to 476 micrometers.

The protective film 195 is arranged on the first dielectric 190a and the second dielectrics 190b. The protective film 195 includes magnesium oxide, and the like. Upon discharging, the protective film 195 protects the dielectrics against impacts of anions and increases secondary electron emission. The protective film 195 may have a bilayer structure. A first layer being in contact with the dielectric is composed of a thin film and a second layer being in contact with the discharge region is composed of a magnesium oxide single crystal in the form of a nanopowder, and may thus have an uneven surface. Upon gas discharging, the surface area of ultraviolet ray ions which collide with the protective film is increased and the number of electrons participating in secondary emission is thus increased and a discharge firing voltage is reduced. As a result, discharge efficiency can be improved and a jitter can be reduced.

A plurality of address electrodes 120 are arranged on one side of the lower substrate 110 such that each of them crosses the associated sustain electrode pairs 180a and 180b. A white dielectric 130 is arranged over the entire surface of the lower electrode 110 while covering the address electrodes 120. The white dielectric 130 is formed by applying a dielectric material onto the lower substrate 110 through printing or film laminating and baking the material. A barrier rib 140 is arranged on the white dielectric 130 such that it is interposed between the adjacent two address electrodes 120. The barrier rib 140 may be a stripe-, well-, or delta-type.

Although not shown, a black top 145 may be arranged on the barrier rib 140. One of Red (R), green (G) and blue (B) phosphor layers 150a, 150b and 150c is interposed between the adjacent barrier ribs 140. A plurality of discharge cells are each defined by an intersection between an associated one of the address electrodes 120 arranged on the lower substrate 110 and an associated one of the sustain electrode pairs 180a and 180b on the upper substrate 170.

The PDP according to one embodiment of the present invention can exhibit a reduced discharge firing voltage and an increased consumption power owing to topology of the dielectric arranged on the upper substrate. In addition, the dielectrics arranged on the upper substrate are partially colored, thus reducing external light reflection, increasing a bright room contrast ratio and increasing a color temperature.

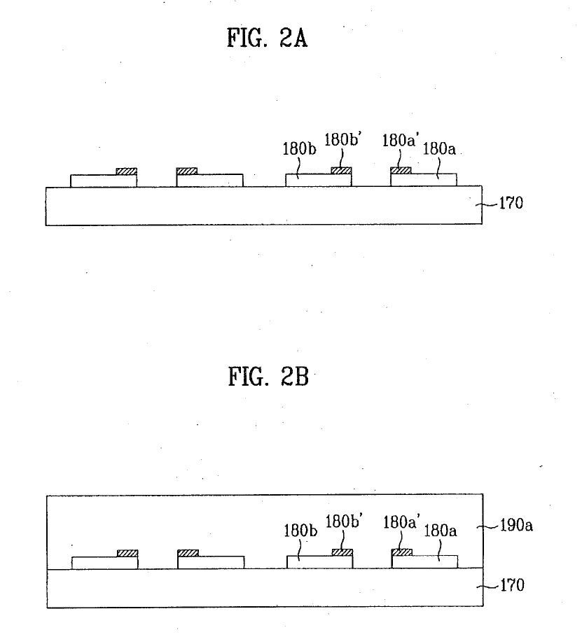

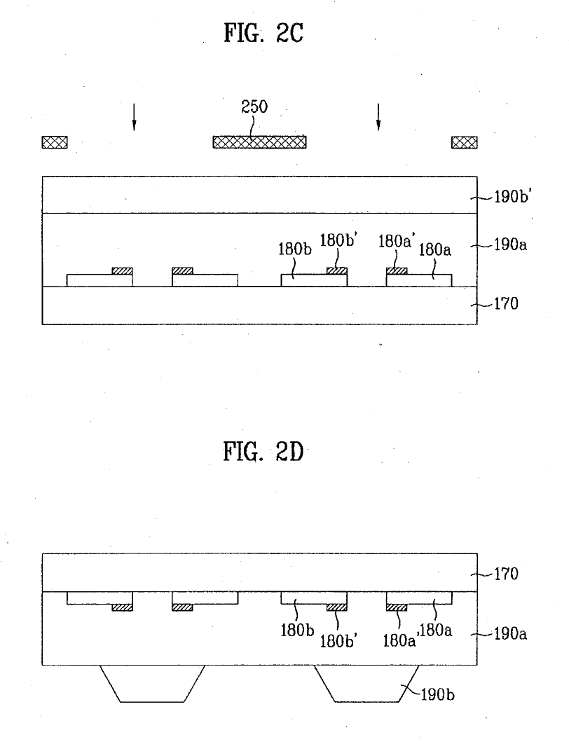

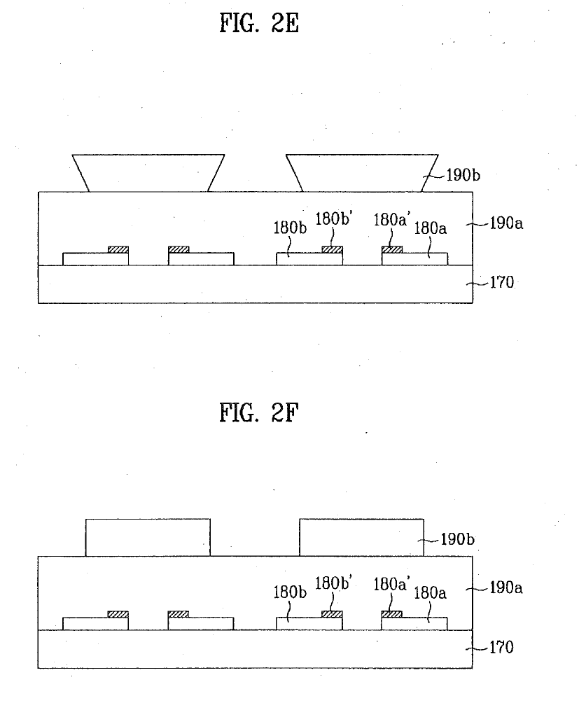

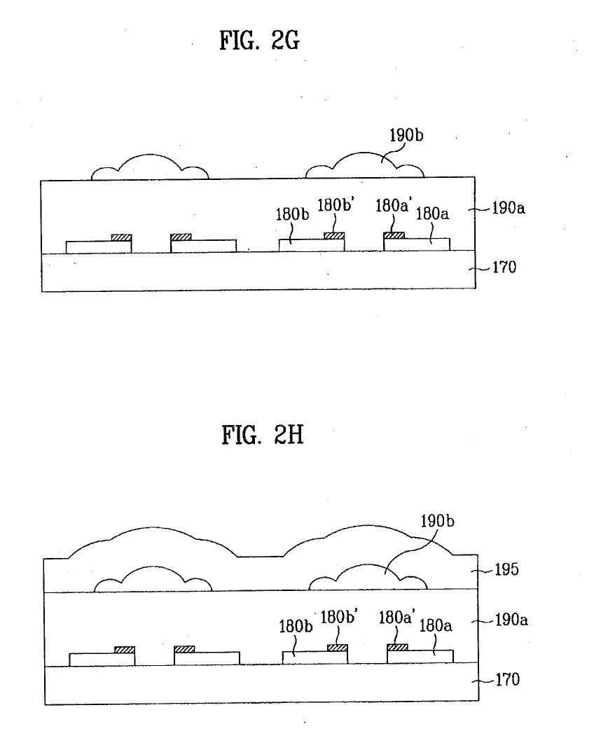

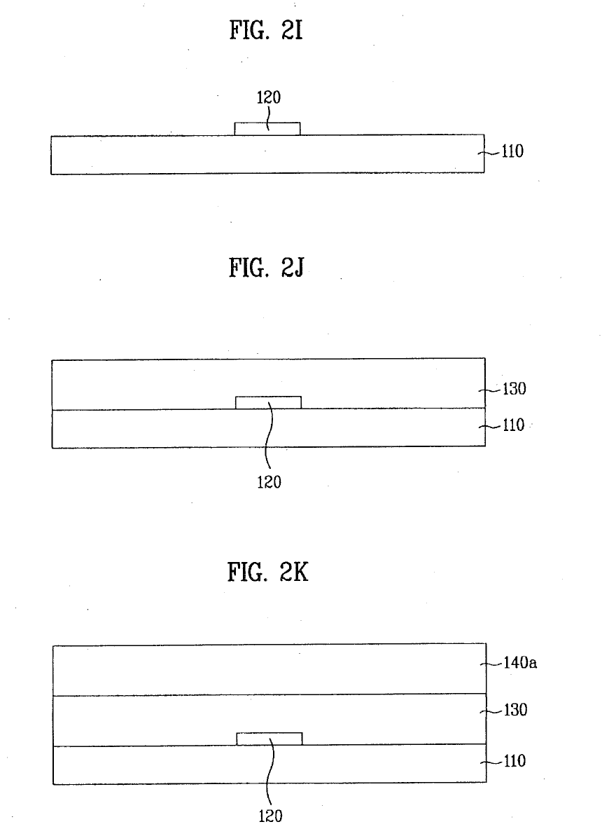

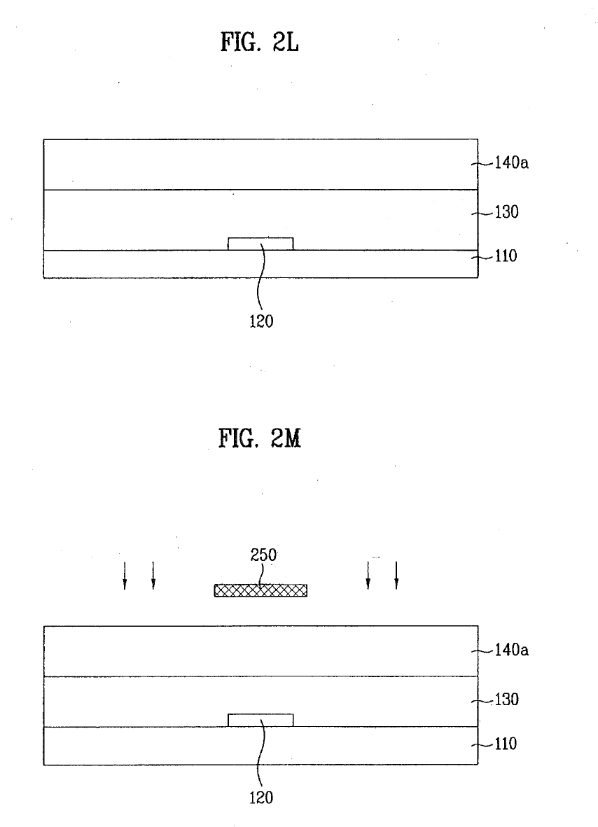

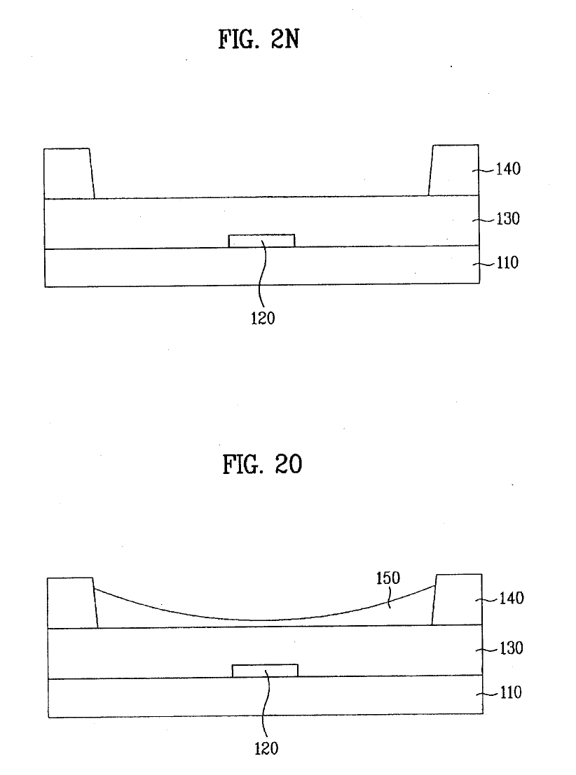

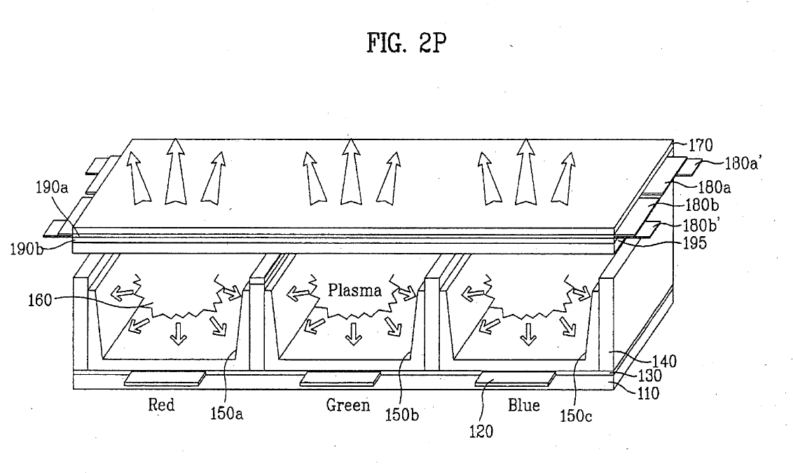

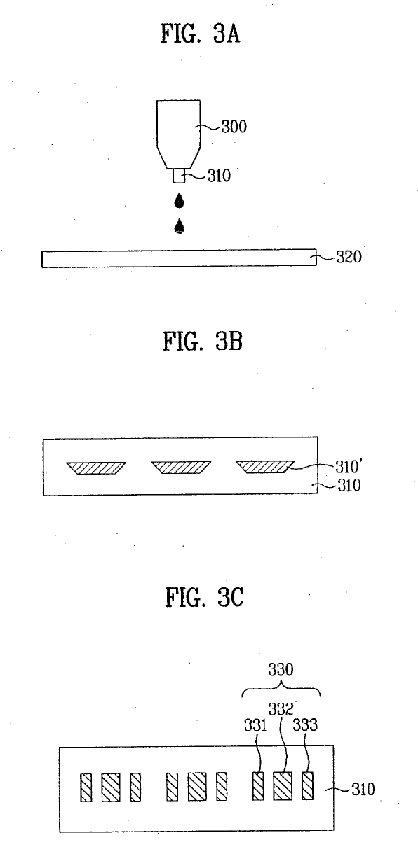

FIGS. 2A to 2P are sectional views illustrating a method for manufacturing a plasma display panel (PDP) according to one embodiment of the present invention. FIGS. 3A to 3C are views illustrating a dispensing system according to embodiments of the present invention. Referring to FIGS. 2A to 2P and 3A to 3C, a method for manufacturing a plasma display panel (PDP) according to the present invention will be illustrated.

As shown in FIG. 2A, a pair of sustain electrodes 180a and 180b and a pair of bus electrodes 180a′ and 180b′ are formed on an upper substrate 170. The upper substrate 170 is formed by milling a substrate-purpose glass or a soda-lime glass and then cleaning the glass.

The sustain electrode pairs 180a and 180b are formed by a photoetching method through sputtering of a material such as ITO (indium-tin-oxide) or SnO₂, or a lift-off method through chemical vapor deposition (CVD) of the material. The bus electrodes 180a′ and 180b are formed by a screen-printing or photosensitive-paste method using a material such as silver (Ag). A black matrix is formed on the sustain electrode pairs 180a and 180b. The black matrix is formed by a screen-printing or photosensitive paste method using a low melting point glass and a black pigment.

As shown in FIG. 2B, a first dielectric 190a is formed over the upper substrate 170 where the sustain electrodes 180a and 180b, and the bus electrodes 180a′ and 180b′ are arranged. The first dielectric 190a is deposited to a thickness of about 5 to 30.5 micrometers by screen printing or coating a transparent low-melting point glass or laminating a green sheet (in the case of XGA Grades).

Subsequently, a second dielectric 190b is formed on the first dielectric 190a. As shown in FIG. 2C, first, a second dielectric material 190b′ is applied to the surface of the first dielectric 190a, followed by patterning. The second dielectric material 190b′ includes metal oxide, in addition to a transparent low-melting point glass. The applying and patterning of the second dielectric material 190b′ allow formation of the second dielectric 190b having topology as shown in FIG. 2D.

There are several methods, e.g., screen printing or sanding, to form the second dielectric 190b.

The screen printing method is a technique that prints a second dielectric material 190b′ several times in a region, where the second dielectric 190b is intended to be formed. The formation of the second dielectric 190b using screen printing is carried out by printing a paste-type material at a predetermined pattern. The screen printing involves a simple process and employs inexpensive equipment.

However, the screen printing has bad uniformity of thickness and width, thus causing a deterioration in precision of a high-definition pattern. Further, the screen printing method leaves mesh marks of a screen mask even after a baking process, thus lowering a surface roughness. Particularly, in a large-sized panel, the screen printing method deforms the screen mask, thus causing disagreement of patterns.

The formation of the second dielectric 190b having a differential structure using the sanding method is carried out by forming a dielectric material by a green sheet technique, patterning a mask thereon, and cutting selectively a unnecessary portion using a kinetic energy of cutting particles, e.g., ceramic particles or ultra-fine particles of calcium carbonate, injected thereto at a high voltage. The sanding method enables formation of a layer to a width not more than 50 micrometers. However, the sanding method has problems of environmental contamination due to dust and cracks in a fine-definition pattern which results from the collision energy of the cutting particles.

Meanwhile, in the case where a coating or green sheet method is used to form the second dielectric 190b, a dielectric material is applied to the first dielectric 190a and then patterned. As shown in FIG. 2C, the second dielectric material 190b′ is applied to the surface of the first dielectric 190a and is then patterned. As one example of patterning, selective etching through a mask 250 is shown in FIG. 2C.

As shown in FIG. 2C, light is selectively transmitted in a region only where there is no mask 250. After completion of the exposing process, the resulting structure is subjected to developing and baking, to complete the manufacture of the second dielectric 190b, as shown in FIG. 2D. During the baking, the width of the second dielectric 190b can be adjusted to a desired level over control of the width of the mask 250.

A more detailed explanation of the patterning process will be given below.

The mask 250 is positioned above the resulting structure, and irradiation is performed in a region only where the second dielectric 190b is intended to be formed. Preferably, the irradiation is selectively applied to the second dielectric material 190b′ present in a non-discharge zone. That is to say, in XGA grade PDPs, layers having a width of about 276 to 476 micrometers only are subjected to the irradiation. As a result, the second dielectric 190b is patterned to have topology and a thickness of 7.5 to 33 micrometers. In addition, although the shape of the second dielectric 190b shown in FIG. 2D is a trapezoid, it may be a rectangle, as mentioned in the following section.

The second dielectric 190b has a chromatic color, gray or black. When the metal oxide contained in the second electrode dielectric material 190b′ includes one selected from cobalt oxide, copper oxide, manganese oxide and chrome oxide, the final second dielectric 190b is blue in color.

Hereinafter, preferred embodiments of a method for forming the second dielectric using a dispensing system are illustrated.

FIG. 3A is a sectional view illustrating a portion of a dispensing system.

A dielectric material stored in a dispenser 300 is applied through a nozzle to a substrate. The shape and thickness of the dielectric material applied to the substrate are varied according to a moving speed of the dispenser 300 and an amount of dielectric material discharged from the nozzle.

FIG. 3B is a view illustrating a nozzle of the dispensing system shown in FIG. 3A. As shown in FIG. 3B, injection ports 310′ included in the nozzle 310 are in the form of an inverse-trapezoid. Accordingly, the dielectric material 190b′ which is injected through the injection ports 310 is applied to the first dielectric 190a in the form of an inverse-trapezoid by a predetermined distance, as shown in FIG. 2E. More specifically, the inverse-trapezoid of the injection ports 310′ have a top length and a bottom length, whose ratio is in a range of 1.5:1 to 2:1. Accordingly, the second dielectric material 190b′ is applied in the form of a trapezoid to the first dielectric 190a. The term “reverse-trapezoid” used herein means a cross-sectional shape of the second dielectric material 190b′. The second dielectric material 190b′ has a hexahedron structure in which a top area is larger than a bottom area.

As mentioned above, after a differential dielectric structure is formed by applying the first dielectric 190a and the second dielectric material 190b′, the dielectric is subjected to drying and baking. The drying is a process to remove a solvent contained in the dielectric material and is preferably carried out at 100 to 150° C. Subsequently, the baking of the dielectric material is carried out at 500 to 600° C.

During the drying and baking, the flowable dielectric material undergoes partial deformation. That is, the reverse-trapezoid dielectric material 190b′ flows down at both edges of the top thereof, resulting in formation of a differential dielectric structure having a rectangle-like shape. That is, when the second dielectric material 190b′ is applied in a rectangular shape, the top thereof is partially collapsed during drying and baking, making the top curved or the overall structure a trapezoid. Accordingly, the dielectric material is applied such that it has a differential structure as a reverse-trapezoid form, and then subjected to drying and baking, to form a dielectric having a differential structure, i.e., a rectangle-like shape.

FIG. 3C is a view illustrating a nozzle of the dispensing system according to another embodiment of the present invention. The dispensing system according to the present embodiment allows a dielectric material to be applied through the injection port of the nozzle. The shape and thickness of the dielectric material applied to the substrate are varied according to a moving speed of a dispenser and the amount of the dielectric material injected. As shown in FIG. 3C, the dispensing system includes a nozzle 310 in which injection ports 331, 332 and 333 are grouped. Specifically, injection ports are not spaced from one another by a predetermined distance, but constitute a plurality of injection port groups 330. Each injection port group 330 is composed of two or more injection ports. The injection port group 330 shown in FIG. 3C is composed of three injection ports. The injection port group 330 has a horizontal length of 200 to 400 micrometers and a vertical length of 100 to 300 micrometers. At this time, the horizontal and vertical directions are the same as FIG. 3C. That is, the direction toward the adjacent injection port is a horizontal direction.

FIG. 2G is a cross-sectional view illustrating the second dielectric material applied using the dispensing system shown in FIG. 3C according to one embodiment. As shown in FIG. 2G, a second dielectric material 190b′ is formed on the first dielectric 190a. At this time, inks applied through respective injection ports constituting each injection port group join together to form the second dielectric material 190b′. That is, although two injection ports may constitute one injection port group, in the present embodiment, three injection ports constitute one injection port group, and each second dielectric 190b is thus bent and has the three highest peaks. In the present embodiment, since the center-positioned injection port of each injection port group discharges the largest amount of ink, the middle peak is the highest of the three highest peaks.

As mentioned above, a differential dielectric structure is formed by applying the first and second dielectric materials, and then subjected to drying and baking. Further details of such a process are the same as in the first embodiment.

During the drying and baking, the flowable dielectric material undergoes partial deformation. That is, the uppermost part of inks which are discharged from injection ports constituting each injection port group partially flows down and then joins the adjacent region. As a result, a differential dielectric structure having a rectangle-like shape is formed, as shown in FIG. 2F. When the second dielectric material 190b′ is applied in a rectangular shape, the top thereof is partially collapsed during drying and baking, making the top curved or the overall structure a trapezoid.

Accordingly, in the present embodiment, several differential dielectrics are applied to be adjacent to each other. During drying and baking, a portion of inks flow down and join together to form a rectangle shape. The injection port groups are designed such that they are spaced apart from each other by a long distance. For this reason, the second dielectric material composed of inks discharged from different injection port groups does not conglomerate, maintaining its overall differential structure.

Subsequently, as shown in FIG. 2H, a protective film 195 is deposited on the second dielectrics. Each second dielectric 190b has a differential structure in the form of a trapezoid, but may have a structure as shown in FIG. 2D. The protective film 195 may include a dopant, e.g., silicon (Si). The protective film 195 is formed by chemical vapor deposition (CVD), E-beam, ion-plating, a sol-gel method, a sputtering method, and the like. When silicon is doped into the protective film 195, a jitter value of an address period is decreased. In order to decrease such a jitter value, other materials may be used, instead of silicon. The protective film may be composed of a first protective film in the form of a thin film and a second protective film in the form of a single-crystalline nanopowder.

As shown in FIG. 2I, an address electrode 120 is formed on a lower substrate 110. The lower substrate 110 is formed by processing (including milling, cleaning and the like) a substrate-purpose glass or a soda-lime glass. Then, an address electrode 120 is formed on the lower substrate 110a. The address electrode 120 is formed by a screen-printing method, a photosensitive paste method, or a photoetching method following sputtering a material such as silver (Ag).

As shown in FIG. 2J, a lower dielectric 130 is formed on the lower substrate 110 where the address electrode 120 is formed. The lower dielectric 130 is formed by screen printing or green sheet laminating using a low-melting point glass and a filler such as TiO₂. Preferably, the lower dielectric 130 is white in color to improve the brightness of plasma display panels.

Subsequently, as shown in FIGS. 2K to 2N, barrier ribs are formed to define respective discharge cells. At this time, a barrier rib material 140a is composed of a parent glass and a filler. The parent glass may include PbO, SiO₂, B₂O₃ and Al₂O₃, and the filler may include TiO₂ and Al₂O₃.

The barrier rib material 140a is patterned to form barrier ribs. The patterning is carried out by exposing through a mask and developing. That is, the mask is located in a region corresponding to the address electrode, and the resulting structure is exposed to radiation, and then developed and baked. As a result, an exposed region only remains to form barrier ribs. When the barrier rib material contains a photoresist, it can be readily patterned.

Then, as shown in FIG. 2O, phosphors 150a, 150b and 150c are applied to one side of the lower dielectric 130 being in contact with the discharge zone and the side of the barrier rib. The phosphors R, G and B are sequentially applied by a screen printing or photosensitive paste method at respective discharge cells.

As shown in FIG. 2P, an upper panel is joined to a lower panel such that the barrier rib is interposed between the two panels, sealed together, internal impurities are discharged to the outside, and a discharge gas 160 is then injected therein.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for manufacturing a plasma display panel comprising:
providing a first substrate that includes an address electrode, a dielectric and a barrier rib;
applying a first dielectric to a second substrate that includes a pair of sustain electrodes;
applying, through a dispensing system including a nozzle having a plurality of reverse-trapezoidal injection ports, a plurality of second dielectrics on the first dielectric such that the second dielectrics on the first dielectric have a differential structure;
heating the first dielectric and the second dielectrics;
forming a protective film on the first dielectric and the second dielectrics; and
joining the first substrate to the second substrate.

2. The method according to claim 1, wherein applying the second dielectrics includes applying each of the second dielectrics on the first dielectric in a form of a reverse-trapezoid.

3. The method according to claim 2, wherein during the heating, portions of each of the second dielectrics in the form of the reverse-trapezoid flow down edges of a top surface thereof.

4. The method according to claim 2, wherein the differential shape comprises a rectangular-like shape.

5. The method according to claim 1, wherein each injection port has a top length and a bottom length, and a ratio of the top length to the bottom length is in a range of 1.5:1 to 2:1.

6. The method according to claim 1, wherein the heating includes drying the first dielectric and the second dielectrics at a temperature of 100° C. to 150° C.

7. The method according to claim 1, wherein the heating includes baking the first dielectric and the second dielectrics at a temperature of 500° C. to 600° C.

8. The method according to claim 1, wherein the nozzle includes a plurality of injection port groups, each injection port group comprising at least two injection ports and the second dielectrics are formed by inks discharged from injection ports constituting each injection port group and the second dielectrics are spaced from each other by a predetermined distance.

9. The method according to claim 8, wherein during the heating, the second dielectrics applied through injection ports constituting one injection port flow and join together.

10. The method according to claim 1, wherein the second dielectrics comprise a chromatic, gray or black material.

11. The method according to claim 1, wherein applying the plurality of second dielectrics includes applying a metal oxide-containing dielectric material on the first dielectric.

12. The method according to claim 11, wherein the dielectric material includes a metal oxide selected from the group consisting of cobalt oxide, copper oxide, manganese oxide and chrome oxide.

13. A plasma display panel comprising:
a first substrate and a second substrate joined to each other and having a barrier rib interposed between the first substrate and the second substrate;
an address electrode and a dielectric on the first substrate;
a pair of sustain electrodes and a first dielectric on the second substrate;
a plurality of second dielectrics on the first dielectric, each of the second dielectrics exhibiting one of a chromatic color, a gray color or a black color, and each of the second dielectrics having a topology; and
a protective film on the first dielectric and the second dielectrics.

14. The plasma display panel according to claim 13, wherein the topology comprises a rectangular-like shape.

15. The plasma display panel according to claim 13, wherein the topology comprises a trapezoidal shape.

16. The plasma display panel according to claim 13, wherein each of the second dielectrics includes a metal oxide.

17. The plasma display panel according to claim 16, wherein the metal oxide includes one selected from the group consisting of cobalt oxide, copper oxide, manganese oxide and chrome oxide.

18. The plasma display panel according to claim 13, wherein each of the second dielectrics are formed in a region corresponding to a non-discharge zone of the first dielectric.

19. The plasma display panel according to claim 13, wherein the first dielectric has a thickness of approximately 5 micrometers to 30.5 micrometers.

20. The plasma display panel according to claim 13, wherein the second dielectrics have a thickness of approximately 7.5 micrometers to 33 micrometers.

21. The plasma display panel according to claim 13, wherein the second dielectrics are spaced apart from each other by a distance of 200 micrometers to 400 micrometers.

22. The plasma display panel according to claim 13, wherein each of the second dielectrics has a width of 276 micrometers to 476 micrometers.

23. A method for manufacturing a plasma display panel comprising:
providing a first substrate that includes an address electrode, a dielectric and a barrier rib;
applying a first dielectric on a second substrate that includes a pair of sustain electrodes;
applying, using a dispensing system, a second dielectric on the first dielectric that includes a chromatic, gray or black material to a region corresponding to a non-discharge zone;
heating the first dielectric and the second dielectrics;
forming a protective film on the first dielectric and the second dielectrics; and
joining the first substrate to the second substrate.

24. The method according to claim 23, wherein applying the second dielectrics includes applying the second dielectrics using the dispensing system having a nozzle that includes a plurality of reverse-trapezoidal injection ports.

25. The method according to claim 24, wherein the second dielectrics on the first dielectric have a differential structure.

26. The method according to claim 25, wherein the differential shape comprises a rectangular-like shape.

27. The method according to claim 23, wherein applying the second dielectrics includes applying each of the second dielectrics on the first dielectric in a form of a reverse-trapezoid.

28. The method according to claim 27, wherein during the heating, portions of each of the second dielectrics in the form of the reverse-trapezoid flow down edges of a top surface thereof.

29. The method according to claim 23, wherein applying the second dielectric includes applying the second dielectrics using the dispensing system having a nozzle that includes a plurality of injection port groups, each of the plurality of injection port groups comprises at least two injection ports, and the second dielectrics are formed by inks discharged from injection ports constituting each injection port group.

30. The method according to claim 29, wherein during the heating, the second dielectrics applied through injection ports constituting one injection port flow together.

31. The method according to claim 23, wherein the applying the plurality of second dielectrics includes applying a metal oxide-containing dielectric material on the first dielectric.
